(19) United States
(12) Patent Application Publication
(10) Pub. No.: US 2004/0249733 A1
(43) Pub. Date: Dec. 9, 2004

(54) Systems and methods for charging for printing services

(76) Inventors: James Clough, Boise, ID (US); Brian E. McKinley, Boise, ID (US); David L. Smith, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/455,840

(22) Filed: Jun. 6, 2003

(51) Int. Cl. G06F 17/60

(52) U.S. Cl. 705/34

(57) ABSTRACT

Disclosed are systems and methods for charging for printing services. In one embodiment, a system and a method pertain to receiving with a printing device a print request transmitted by a printing client, determining using the printing device billing information for the client, and transmitting printing charge information from the printing device to a billing system for printing services rendered by the printing device.

### BACKGROUND

Computer users often carry portable computing devices with them such as notebook computers, personal digital assistants (PDAs), and mobile telephones that include computing capabilities. Such users may at some point wish to print data from the portable computing device while remote from the user's home or office desk. For instance, a mobile user may wish to print when at a coffee shop that provides network (e.g., Internet) access and printing services, when staying at a hotel that comprises a hotel network that includes a public printing device, or when located at an unfamiliar location within an enterprise (e.g., conference room).

In such scenarios, it is likely that the user has little or no knowledge of the printing services that are available for use at the location. Furthermore, it is likely that the user lacks the software (or firmware) that is required to communicate with the printing devices and to send print jobs to them. Although the user can be provided with information as to the availability of printing services as well as any software or firmware (e.g., drivers) that is necessary to print, a more automated public printing system would be preferable, particularly for less computer-savvy users. Moreover, desirable would be a public printing system that is substantially universal and therefore may be used within any network that is configured to support such public printing.

Several obstacles exist to the creation and implementation of such a public printing system. For instance, in situations in which the printing services are provided for a fee or if printing charges are to be allocated to a particular division within an enterprise, the system preferably would be designed to, at least partially, automate the billing process.

Several known systems facilitate billing for printing services. Such systems typically require hardware separate from the printing device to track printing device use and information regarding the persons or other entities that are to be charged. For example, in some cases a print server is used that counts the number of pages printed by each user for purposes of per-page billing. In other cases, a server computer is used to periodically query a printing device to determine its current page count so that the total number of pages printed over a given time period can be determined.

In both of the above-identified examples, a separate server computer is required that must be both purchased and maintained. Moreover, in the latter example, it may not be possible to determine who printed which pages, in which case billing on a per-user basis may not be possible.

### SUMMARY

Disclosed are systems and methods for charging for printing services. In one embodiment, a system and a method pertain to receiving with a printing device a print request transmitted by a printing client, determining using the printing device billing information for the client, and transmitting printing charge information from the printing device to a billing system for printing services rendered by the printing device.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system that facilitates public printing.

FIG. 2 is a block diagram of an embodiment of a computing device shown in FIG. 1.

FIG. 3 is a block diagram of an embodiment of a printing device shown in FIG. 1.

FIGS. 4A and 4B provide a flow diagram that illustrates an embodiment of a method for facilitating public printing using the system of FIG. 1.

FIG. 5 is a flow diagram that illustrates an embodiment of operation of a public printing client executing on a printing device in facilitating billing for rendered printing services.

### DETAILED DESCRIPTION

Disclosed herein are example embodiments of systems and methods that facilitate public printing. Although particular embodiments are disclosed, these embodiments are provided for purposes of example only to facilitate description of the disclosed systems and methods.

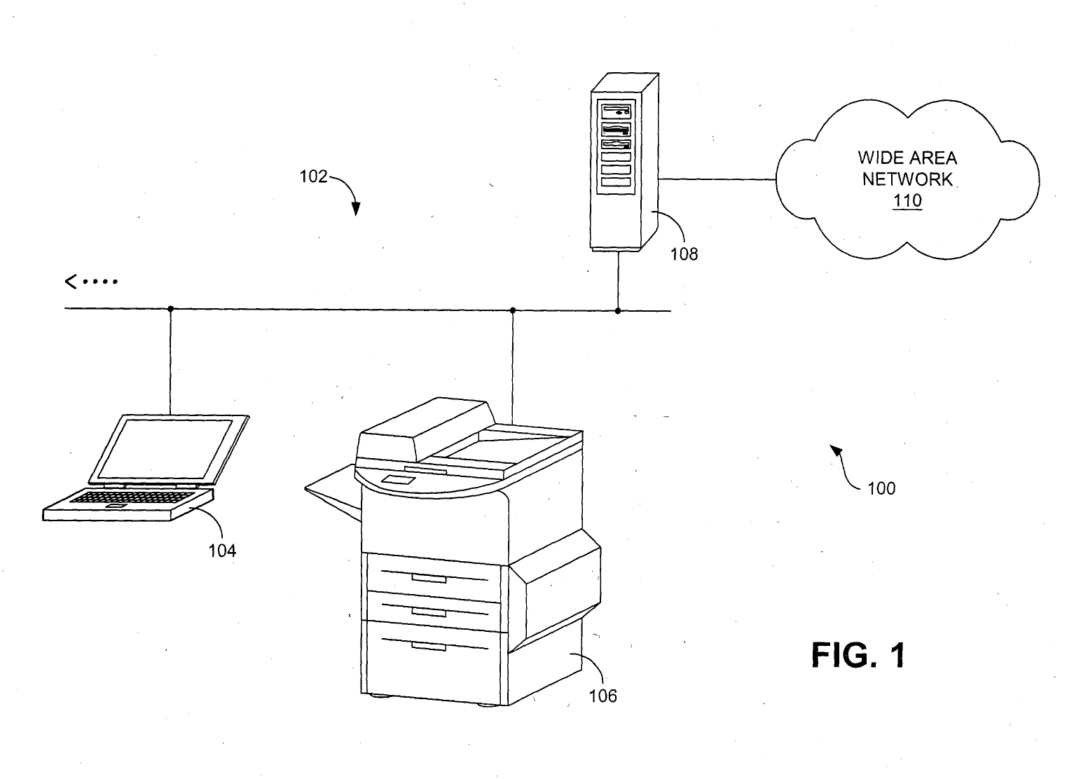

Referring now in more detail to the drawings, in which like numerals indicate corresponding parts throughout the several views, FIG. 1 illustrates an example system 100 that facilitates public printing. As indicated in this figure, the system 100 includes a local or internal network 102 to which a computing device 104, a printing device 106, and a server computer 108 are connected. The internal network 102 is assumed to comprise a network that is unfamiliar to the mobile user. By way of example, the internal network 102 comprises a hotel network to which the user can connect from the user's hotel room. Although a hotel network is explicitly identified for purposes of discussion, the internal network 102 more generally comprises any network (wired or wireless) that a mobile user may wish to connect to and print over.

As is depicted in FIG. 1, the computing device 104 can be a notebook (or “laptop”) computer. More generally, however, the computing device 104 comprises a portable computing device that the mobile user may carry, for instance, while on a business trip or while moving from location to location within an enterprise. Accordingly, the computing device 104 can, alternatively, comprise one of a personal digital assistant (PDA), tablet computer, mobile telephone, etc. Irrespective of its configuration, the computing device 104 is connectable to the internal network 102 such that the computing device can communicate with one or both of the printing device 106 and the server computer 108. This connection may comprise either a wired connection or a wireless connection (e.g., via a radio frequency (RF) communication protocol). Stored on the computing device 104 is client software (or firmware) that is used to access and use a public printing service facilitated by a printing service manager.

The printing device 106 comprises any device that can receive print jobs via the internal network 102 and generate hardcopy documents associated with the received jobs. By way of example, the printing device 106 comprises a laser printer. However, other configurations are possible. For instance, the printing device 106 can be a multi-function peripheral (MFP) device that is capable of printing as well as performing other tasks such as copying, scanning, faxing, emailing, etc. As is described in greater detail below, the printing device 106 can comprise an embedded printing service manager that facilitates public printing as well as billing for the rendered printing services.

The server computer 108 links the internal network 102 to an external wide area network (WAN) 110, such as the Internet, and therefore acts as a gateway between the internal network and the WAN. As is described below, the server computer 108 may be configured to intercept initial communications directed at devices located outside of the internal network 102 (i.e. on the WAN 110). Such interception may be used to, for example, charge users for Internet access and/or offer printing services to the user. In the latter case, the server computer 108 may be configured to provide a link to the printing service manager that, as described above, may be embedded in the printing device 106.

In addition to acting as the network gateway, the server computer 108 (or a separate computer if desired) may be used to provide the network address (e.g., Internet protocol (IP) address) of the printing service manager. Notably, in some embodiments, the printing service manager, or a portion thereof, may exist on the server computer 108 or another device connected to the network 102.

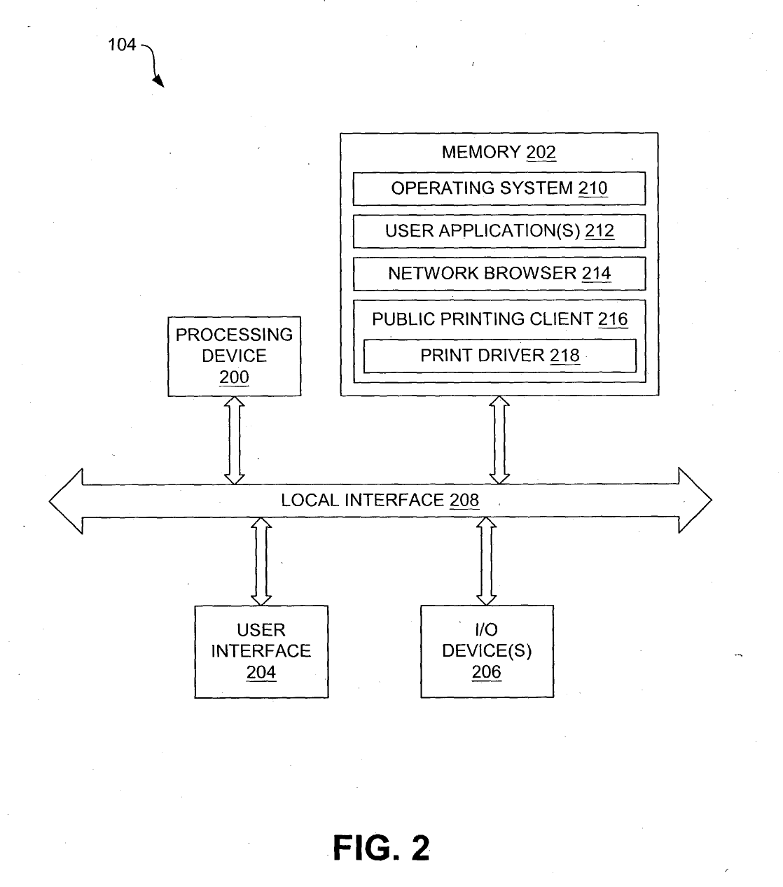

FIG. 2 is a block diagram illustrating an example architecture for the computing device 104 shown in FIG. 1. As indicated in FIG. 2, the computing device 104 comprises a processing device 200, memory 202, a user interface 204, and at least one input/output (I/O) device 206. Each of these components is connected to a local interface 208 that, for instance, comprises one or more internal buses.

The processing device 200 is adapted to execute commands stored in memory 202 and can comprise a general-purpose processor, a microprocessor, one or more application-specific integrated circuits (ASICs), a plurality of suitably configured digital logic gates, or other electrical configurations that coordinate the overall operation of the computing device 104. The memory 202 comprises any one or a combination of volatile memory elements (e.g., random access memory (RAM)) and nonvolatile memory elements (e.g., Flash memory, hard disk, etc.) that store or cache data.

The user interface 204 comprises the tools with which user data and commands are input into the computing device 104. In situations in which the computing device 104 comprises a notebook computer, the user interface 204 at least comprises a keyboard and a display. In other embodiments, the user interface may comprise one or more of function keys, buttons, a touch-sensitive display, and a stylus.

The one or more I/O devices 206 facilitate communications with other devices and may include one or more serial, parallel, small computer system interface (SCSI), universal serial bus (USB), Ethernet, or IEEE 1394 (e.g., Firewire™) components, as well as one or more of a modulator/demodulator (e.g., modem), network card, wireless (e.g., RF) transceiver, or other communication component.

The memory 202 includes various programs, in software and/or firmware, including an operating system 210, one or more user applications 212, and a network browser 214. The operating system 210 controls the execution of other software and provides scheduling, input-output control, file and data management, memory management, and communication control and related services. The user applications 212 comprise the programs that may be used to create and/or identify data (e.g., documents) that is to be printed by the service and, more particularly, by the printing device 106. By way of example, these applications comprise one or more of a word processing application, a spreadsheet application, a presentation application, a scheduling application, etc. The network browser 214 comprises a program with which the user can access, via the internal network 102, network sites and pages. By way of example, the network browser 214 is an Internet browser that retrieves Web sites and Web pages. As is described below, the network browser 214 can be used to access the printing service manager.

In addition to those programs, the memory 202 comprises a public printing client 216. As is described in greater detail below, the public printing client 216 operates in conjunction with the printing service manager to facilitate public printing. By way of example, the public printing client 216 can be downloaded from the printing service manager or from a suitable source on the WAN 110. In any case, however, once stored on the computing device 104, the public printing client 216 can be used to facilitate public printing on any network in which an appropriate printing service manager is provided, thereby providing a substantially universal printing solution.

As is further identified in FIG. 2, the public printing client 216 includes a print driver 218 that is used to translate documents into an appropriate print format. Alternatively, however, the driver 218 could comprise part of the operating system 210. In preferred embodiments, the print driver 218 is a universal driver that can be used in conjunction with substantially any printing device that may be accessed via a compatible printing service manager.

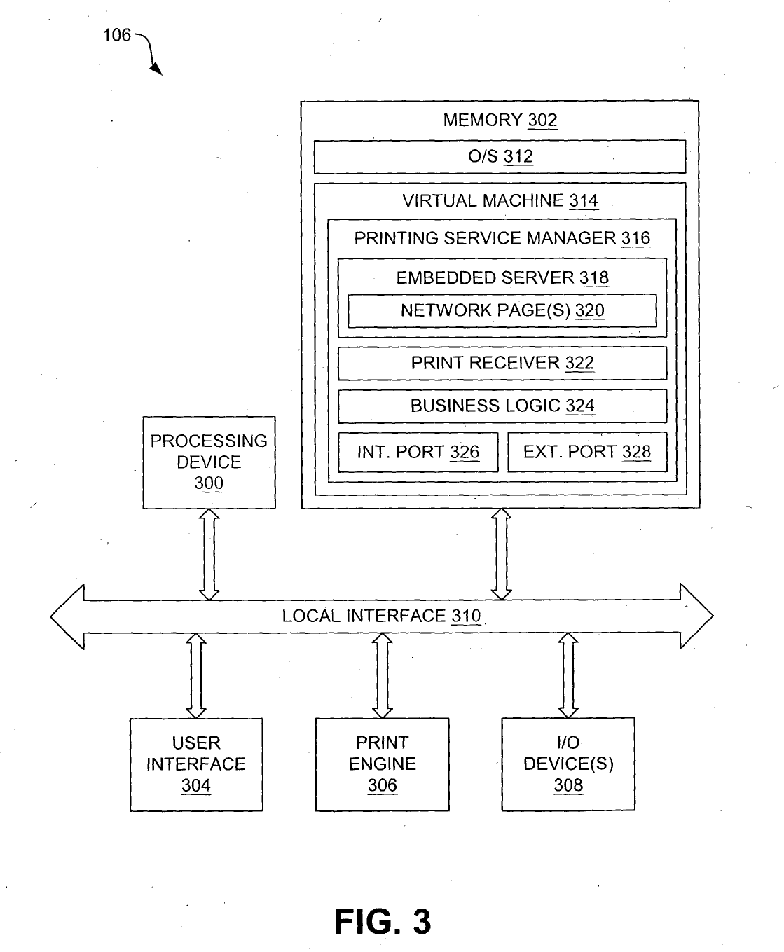

FIG. 3 is a block diagram illustrating an example architecture for the printing device 106 shown in FIG. 1. As indicated in FIG. 3, the printing device 106, like the computing device 104, comprises a processing device 300, memory 302, a user interface 304, and at least one I/O device 308, each of which is connected to a local interface 308. In addition, however, the printing device 106 comprises a print engine 306.

The processing device 300, memory 302, and I/O devices 308 have similar configurations to like-named components of the computing device 104 described in relation to FIG. 2. The user interface 304 comprises the components with which users input commands and modify device settings, such as a control panel that incorporates a display (e.g., liquid crystal display (LCD)) and a series of keys or buttons.

The memory 302 comprises various programs, in software and/or firmware, including an operating system 312 and, in this embodiment, a virtual machine 314. The operating system 312 contains the various commands that are used to control the general operation of the printing device 106. The virtual machine 314 is a program that functions as a self-contained operating environment and facilitates operation of a printing service manager 316 that, as noted above, facilitates public printing. Although a virtual machine is explicitly shown and identified, its functionality could, alternatively, be provided by software or firmware stored in the printing device 106. In the embodiment of FIG. 3, however, the manager 316 comprises an applet (e.g., written in the Chai™ programming language of the Hewlett-Packard Company) that includes an embedded server 318, a print receiver 322, and business logic 324.

The embedded server 318 is configured to serve network pages 320, for instance Web pages, to requesting devices such as the computing device 104. As is described below, these pages contain information for the user as to how to use the public printing system hosted by the printing service manager 316, how to obtain public printing client software, the cost of the printing services, the methods of paying for those services, etc.

The print receiver 322 is a module that is configured to receive print jobs transmitted to the printing device 106 via the internal network 102. By way of example, the print receiver 322 is specifically configured to receive hypertext transfer protocol (HTTP) and/or secure HTTP (HTTPS) communications. These communications can, for example, be received via an internal port 326 and/or an external port 328 that each has its own network address (e.g., universal resource locator (URL)) that is used to access the port. In some embodiments, the internal port 326 and the external port 328 may comprise the same port. When a print job is received, the print receiver 322 forwards the job to the print engine 306 for printing.

Once printing has been successfully performed, billing (assuming the printing services are provided on a pay basis) is facilitated using the business logic 324. Operation of the business logic 324 depends upon the particular implementation and method of billing that is to be used. By way of example, the business logic 324 is configured to communicate printing charge information to a billing system (e.g., the server computer 108) for purposes of posting those charges to a bill (e.g., hotel bill) or contacting an appropriate credit card processing service.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can used by or in connection with an instruction execution system, apparatus, or device, such as a computer-based system, processor-containing system, or other system that can fetch the instructions from the instruction execution system, apparatus, or device and execute the instructions.

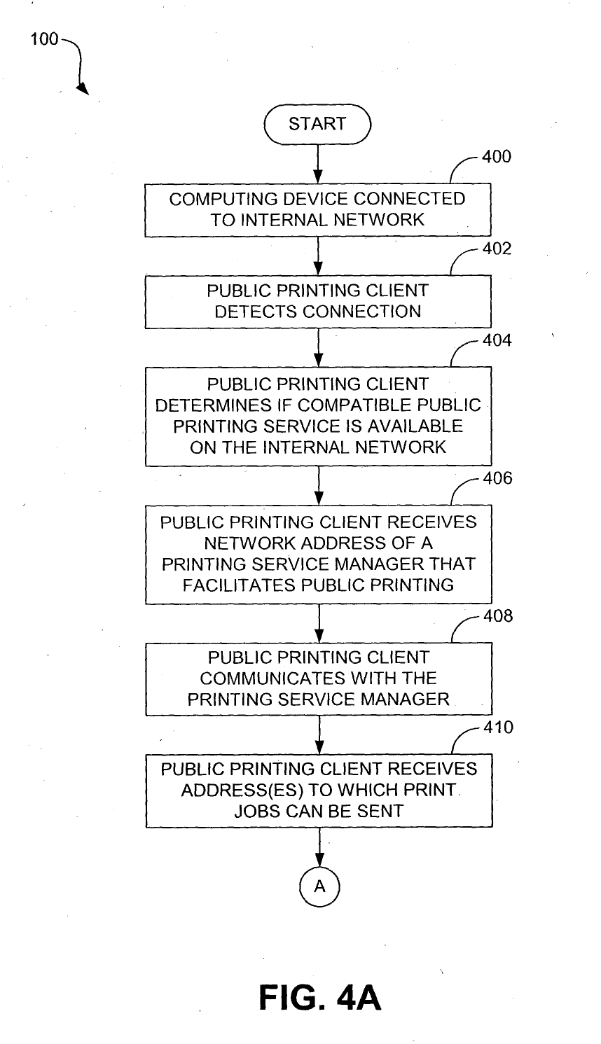

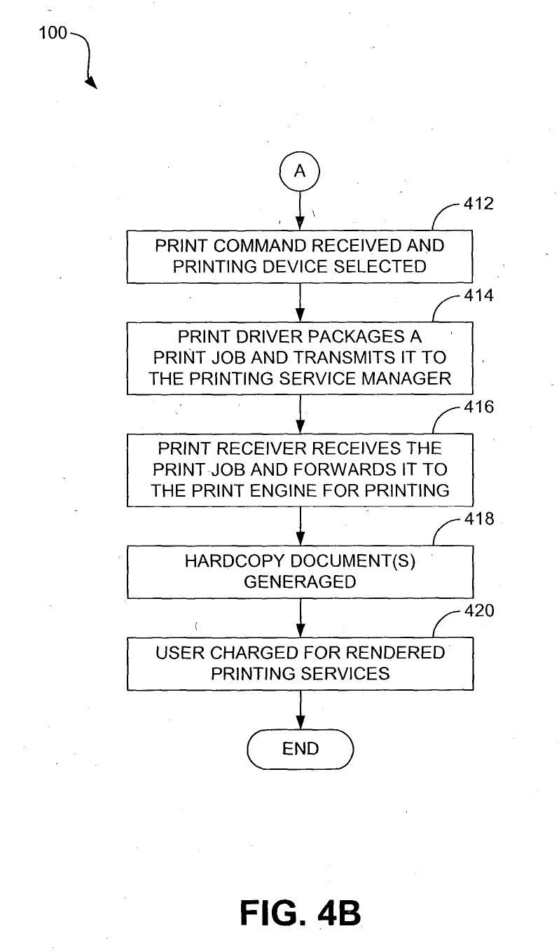

An example system having been described above, an example of operation of the system in facilitating public printing will now be discussed in relation to the flow diagram of FIGS. 4A and 4B. Process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 400 of FIG. 4A, the computing device 104 (FIG. 1) is connected to the internal network 102. Once the computing device 104 is connected to the network 102, the public printing client 216 (FIG. 2) on the computing device detects the connection, as indicated in block 402. Such detection can be made because the public printing client 216 continuously runs in the background on the computing device 104 and therefore continually monitors the network state of the device. Notably, the public printing client 216 could have been installed in a previous public printing session. For example, during that session, the computer user could have been made aware of the availability of the client software and the printing services it facilitates by, for example, a Web page served by the server computer 108. In such a case, the client software could have been obtained by, for instance, retrieving it from a server connected to the WAN 110 and operated by or on the behalf of the client software developer.

Referring next to block 404, the public printing client 216 determines if a compatible public printing service is available on the internal network 102. This determination can be made by performing a domain name service (DNS) lookup for a domain name associated with the public printing service that a DNS server (e.g., server computer 108) is configured to recognize. By way of example, a DNS lookup of the name “mobile.printing” can be performed. If a compatible public printing service is available, the public printing client 216 receives a network address of a printing service manager 316 (FIG. 3) that facilitates such public printing, as indicated in block 406. More particularly, the public printing client 216 receives an Internet protocol (IP) address of the printing service manager 316, for example stored on the printing device 106.

Once the public printing client 216 receives the address of the printing service manager 316, the public printing client makes a call to that address so that the client can communicate with the printing service manager 316, as indicated in block 408. Such communications are supported using an appropriate network protocol, such as HTTP or HTTPS. Through these communications, the public printing client 216 receives one or more network addresses to which print jobs can be sent for printing by one or more available printing devices 106, as indicated in block 410. By way of example, the address or addresses comprise one or more URLs that identify input ports (e.g., the internal and external ports) of the printing service manager 316 on the printing device 106 or the server computer 108. This information, as well as other information that facilitates printing, can, for instance, be contained in an extensible markup language (XML) document that is transmitted from the printing service manager 316 to the public printing client 216. At this point, the public printing client 216, and therefore the computing device 104, has completed a public printing service discovery process and therefore is prepared to print to the printing device 106.

The user can learn about the public printing service in various ways. For example, when the user opens the network browser 214, the server computer 108 can intercept that connection and inform the user as to the availability of the public printing service and provide a link to the printing service manager 316. Assuming the user wishes to use or is considering using the public printing service, the user can then select the link and receive one or more network (e.g., Web) pages from the embedded server 318 of the printing service manager 316 that explain how to use the service, how much the service costs (e.g., price per page), how the user is billed, where printed documents may be picked up, etc.

At print time, a print command is received and a printing device is selected, as indicated in block 412 of FIG. 4B. By way of example, the print command and printing device selection are made using a “File, Print” process in which the user is presented with a list of available printing devices from which to choose. In such a case, the presented list includes the printing device 106 connected to the internal network 102. After the print command and printing device selection have been entered, and assuming the user selected the printing device 106, the public printing client 216 packages a print job and transmits it to the printing service manager 316, as indicated in block 414. Alternatively, however, packaging of the print job can have occurred previous to entry of the print command and printing device selection. Preferably, the print job is transmitted using a secure network protocol such as HTTPS. Regardless, the print job is transmitted to an address (e.g., URL) that the public printing client 216 received in block 410 described above.

After or while the print job is transmitted, the print receiver 322 of the printing service manager 316 receives the print job and forwards it to the print engine 306 for printing, as indicated in block 416, so that, as indicated in block 418, one or more hardcopy documents are generated. If the printing service manager 316 is executing on a device separate from the printing device 106, for instance on the server computer 108, the print job is transmitted from that device to the printing device using substantially any available transmission method (wired or wireless). Optionally, this transmission can also be via HTTP or HTTPS. Once printing has been successfully completed (in whole or in part), the user is charged for the printing services rendered, as indicated in block 420. As noted above, such a charge can be, for instance, added to a hotel bill or forwarded to a credit card processing service for debiting of a credit card account. Assuming no other documents are to be printed, flow for the public printing session is then terminated.

As is apparent from the foregoing, it is desirable to have a printing system that, at least partially, automates the billing process and that does not require the purchase and maintenance of separate hardware, such as a print server. In cases in which the print service manager 316 executes on the printing device 106, billing can be automatically facilitated without the need for separate hardware.

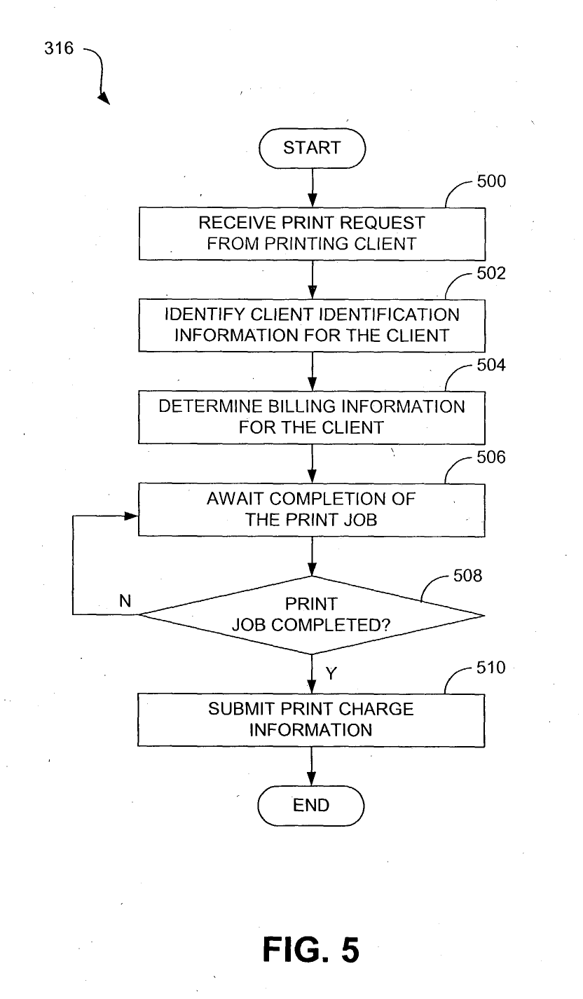

FIG. 5 is a flow diagram that describes an example embodiment of a method for billing for rendered print services. More particularly, FIG. 5 illustrates an example of operation of the printing service manager 316 (FIG. 3) executing on the printing device 106 (FIG. 1) in facilitating billing of a user for printing with the public printing service. Beginning with block 500 of FIG. 5, the printing service manager 316 receives a print request. By way of example, this request can have been received via a port (e.g., internal port 326 or external port 328) by the print receiver 322, and may have been contained in initial packets of a print job transmitted by a public printing client 216 (FIG. 2).

Upon receiving the request, the service manager 326 identifies the network address of the public printing client 216, as indicated in block 502. By way of example, the printing service manager 316 identifies the IP address of the public printing client 216 from data contained within the client communication. Although not indicated in FIG. 5, the printing service manager 316 can further verify the public printing client's authorization to use the public printing service. Such verification can be accomplished by, for instance, determining one or more of an authorization code and client ID (e.g., media access control (MAC) address) for the client and/or client device, and cross-referencing this information with information contained in a client database stored on the printing device or other device.

Assuming that the public printing client 216 is authorized to use the public printing service, the public printing manager 316 next determines billing information for the public printing client, as indicated in block 504. Such billing information may comprise one or more of a user name, a guest room number, a billing code, a name of a credit provider and a credit card number, and so forth. This billing information can be obtained by performing a lookup process using client identification information (e.g., the identified IP address, authorization code, and/or MAC address) on a client database stored within printing device memory, or by communicating (i.e., transmitting) the client information to another device that acts as a billing information source, such as the server computer 108, and which may comprise such a client database. In the latter case, the other device may be, for instance, a property management system computer that contains a database of hotel guests and billing information the guests provided.

Once the billing information has been determined, the printing service manager 316 awaits completion of the print job, as indicated in block 506, so that the amount to be billed to the client 216 (user) can be determined. Optionally, if the charges are to be posted against a user account such as a bank account or credit card account, pre-approval for the charges that will be due may be obtained prior to enabling printing. In such a case, the availability of funds for the requested printing may be a precondition to printing. Assuming printing was deemed permissible and was begun, it is next determined in decision block 508 whether the print job has been completed. This determination is made, for instance, from the receipt (or lack of receipt) of a “job completed” indication provided by the print engine 306.

After the print job has been completed, flow continues to block 510 at which the printing service manager 316 submits (i.e., transmits) printing charge information to an appropriate billing system using the determined billing information. The charge information may comprise, for instance, the number of pages that were printed for the client print job or an actual dollar (or other currency) amount that has been calculated in accordance with a fee schedule that is stored within printing device memory 202. Regardless, if billing is on a per-page basis, the printing system manager 316 at least determines the number of pages printed for the client 216.

The billing system to which the charge information is submitted depends upon the particular configuration of the system in which the public printing service is provided. In the case of a hotel, the billing system may comprise a property management system computer (e.g., server computer 108) that records and computes guest charges. In other cases, the billing system may comprise a server computer of a credit card service that is accessible via the WAN 110. Notwithstanding, information needed to bill the client 216 is provided, and flow for the printing/billing session is then complete.

In the example embodiment described above, billing for printing services is directly integrated into the printing device 102. With such an arrangement, separate hardware, such as a print server or other computer, is not needed to facilitate client billing.

What is claimed is:

1. A method for charging for printing services, comprising:
receiving with a printing device a print request transmitted by a printing client;
determining using the printing device billing information for the client; and
transmitting printing charge information from the printing device to a billing system for printing services rendered by the printing device.

2. The method of claim 1, wherein receiving a print request comprises receiving a print job transmitted to a port of the printing device by the printing client.

3. The method of claim 1, wherein determining billing information comprises identifying on the printing device client identification information.

4. The method of claim 3, wherein identifying client identification information comprises identifying an Internet protocol (IP) address of the printing client.

5. The method of claim 3, wherein identifying client information comprises determining at least one of an authorization code and a media access control (MAC) address associated with the printing client.

6. The method of claim 3, further comprising transmitting from the printing device the client identification information to a billing information source via a network.

7. The method of claim 1, wherein determining billing information comprises determining at least one of a user name, a guest room number, a billing code, and a credit card number.

8. The method of claim 1, wherein transmitting print charge information comprises transmitting print charge information to a management system of a hotel via a network.

9. The method of claim 1, wherein transmitting print charge information comprises transmitting print charge information to a credit card service via a network.

10. The method of claim 1, wherein transmitting print charge information comprises transmitting a number reflective of a number of pages that were printed.

11. The method of claim 1, wherein transmitting print charge information comprises transmitting a currency amount to be charged.

12. The method of claim 1, further comprising determining the availability of funds for the printing client prior and enabling or disabling printing based upon the determined availability.

13. A system for charging for printing services, comprising:
means provided on a printing device for receiving a print request transmitted by a printing client;
means provided on the printing device for determining client identification information for the printing client;
means provided on the printing device for determining billing information for the printing client using the client identification information;
means provided on the printing device for determining printing charge information associated with pages printed for the printing client; and
means provided on the printing device for transmitting printing charge information to a billing system.

14. The system of claim 13, wherein the means for determining billing information comprise means for identifying a network address of the printing client.

15. The system of claim 14, wherein the means for determining billing information comprise means for transmitting the network address to a billing information source and receiving back billing information.

16. The system of claim 15, wherein the means for determining billing information are configured to receive at least one of a user name, a guest room number, a billing code, and a credit card number.

17. A printing device, comprising:
a print engine;
a processing device; and
memory comprising a printing service manager that is configured to receive a print request transmitted by a printing client, determine client identification information for the printing client, determine billing information for the client using the client identification information, and transmit printing charge information to a billing system using the determined billing information.

18. The device of claim 17, wherein the printing service manager is configured to determine an Internet protocol (IP) address of the printing client.

19. The device of claim 17, wherein the printing service manager is configured to determine at least one of a user name, a guest room number, a billing code, and a credit card number.

20. The device of claim 17, wherein the printing service manager is configured to transmit a number reflective of a number of pages that were printed.

21. The device of claim 17, wherein the printing service manager is configured to transmit a currency amount to be charged.

22. A printing service manager stored on a computer-readable medium and configured to execute on a printing device, the manager comprising:
logic configured to receive a print job transmitted by a printing client;
logic configured to determine client identification information for the printing client from information contained in the print job;
logic configured to determine billing information for the client using the client identification information; and
logic configured to provide printing charge information to a billing system using the determined billing information.

23. The manager of claim 22, wherein the manager is configured to determine an Internet protocol (IP) address of the printing client.

24. The manager of claim 22, wherein the manager is configured to transmit a number reflective of a number of pages that were printed.

25. The manager of claim 22, wherein the manager is configured to transmit a currency amount to be charged.
